(19) United States
(12) Patent Application Publication
(10) Pub. No.: US 2024/0286665 A1
(43) Pub. Date: Aug. 29, 2024

(54) STEERING DEVICE

(71) Applicants: JTEKT CORPORATION, Kariya-shi, Aichi-ken (JP); FUJIKIKO CO., LTD., Shizuoka (JP)

(72) Inventors: Naofumi KAWAMURA, Kishiwada-shi (JP); Hiroaki SUZUKI, Toyota-shi (JP); Tetsuya EBISU, Shijonawate-shi (JP); Yuki FUJIOKA, Kashiba-shi (JP); Tomonori SUGIURA, Yamatokoriyama-shi (JP); Kosuke ITO, Shiki-gun (JP); Takahiro BAITO, Kosai-shi (JP); Takao NAKAAKI, Kashihara-shi (JP); Yoshiaki MURAKAMI, Hamamatsu-shi (JP); Kazuhisa ASAKAWA, Shiki-gun (JP)

(73) Assignees: JTEKT CORPORATION, Kariya-shi, Aichi-ken (JP); JTEKT COLUMN SYSTEMS CORPORATION, Kosai-shi, Shizuoka (JP)

(21) Appl. No.: 18/571,820

(22) PCT Filed: Jun. 25, 2021
(86) PCT No.: PCT/JP2021/024114

§ 371 Date: Dec. 19, 2023

(51) Int. Cl. B62D 1/16; B62D 5/04

(52) U.S. Cl. CPC B62D 1/16; B62D 5/0403; B62D 5/0409

(57) ABSTRACT

A steering system includes a support tube including a flange and a housing including a cylindrical portion housing a speed reducer. The support tube includes a column bracket attached to a vehicle body. The housing is supported by a support shaft in such a manner that the housing can rotate with respect to the vehicle body. The flange and the cylindrical portion are connected to each other by bolts. The flange has insertion holes into which the bolts are inserted. Clearance that allows relative rotation between the flange and the cylindrical portion is present between the outer peripheral surface of the bolt and the inner peripheral surface of the insertion hole of the flange. An elastic body that reduces the relative rotation between the flange and the cylindrical portion is interposed in a compressed state between the bolt and the flange.

### TECHNICAL FIELD

The present disclosure relates to steering systems.

### BACKGROUND ART

Conventionally, there are electric power steering systems that assist in operating a steering wheel using a motor. For example, an electric power steering system of Patent Document 1 includes an electric assist device. The electric assist device includes a motor and a housing. The housing supports the motor. A worm speed reducer is housed inside the housing. Torque of the motor is transferred to a steering shaft via the speed reducer.

The housing includes a first housing member and a second housing member. The first housing member and the second housing member are fitted together in the axial direction of the steering shaft. A cylindrical steering column is connected to the opposite side surface of the first housing member from the second housing member by bolts. The steering shaft is rotatably supported inside the steering column.

### RELATED ART DOCUMENTS

### Patent Documents

Patent Document 1: Japanese Unexamined Patent Application Publication No. 2013-71590 (JP 2013-71590 A)

### SUMMARY OF THE INVENTION

### Problem to be Solved by the Invention

Improved ease of assembly is desired for steering systems including the electric power steering system of Patent Document 1.

### Means for Solving the Problem

A steering system according to an aspect of the present disclosure includes: a cylindrical support tube that includes a flange and that rotatably supports a steering shaft; a speed reducer configured to apply torque to the steering shaft; a housing that includes a cylindrical portion housing the speed reducer, the cylindrical portion being disposed coaxially with the flange; a column bracket mounted on the support tube and having a mounting surface for a vehicle body; a support shaft that extends in a width direction of the vehicle body and that supports the housing in such a manner that the housing is rotatable with respect to the vehicle body; and a bolt that connects the flange and the cylindrical portion to each other. The bolt includes a head and a shaft. The flange has an insertion hole through which the shaft is inserted. There is clearance between an outer peripheral surface of the shaft and an inner peripheral surface of the insertion hole at least in a circumferential direction of the flange. The clearance allows relative rotation between the flange and the cylindrical portion. An elastic body is interposed, in a compressed state in an axial direction of the bolt, between the head and the flange, so that the elastic body applies an elastic force that reduces the relative rotation between the flange and the cylindrical portion.

### BRIEF DESCRIPTION OF THE DRAWINGS

FIG. 1 is a schematic diagram showing the configuration of a first embodiment of a steering system.

FIG. 2 is a perspective view of a steering column in FIG. 1.

FIG. 3 is an exploded perspective view of a support tube and a housing in FIG. 2.

FIG. 4 is a perspective view of a connecting portion between the housing and a lower tube in FIG. 2.

FIG. 5 is a sectional view of the connecting portion between the housing and the lower tube in FIG. 2.

FIG. 6 is a plan view of a flange of a second embodiment as viewed in an axial direction.

FIG. 7 is a sectional view of the connection portion between the housing and the lower tube in a third embodiment.

FIG. 8 is a sectional view of the connecting portion between the housing and the lower tube in a fourth embodiment.

### MODES FOR CARRYING OUT THE INVENTION

### First Embodiment

A first embodiment of a steering system will be described.

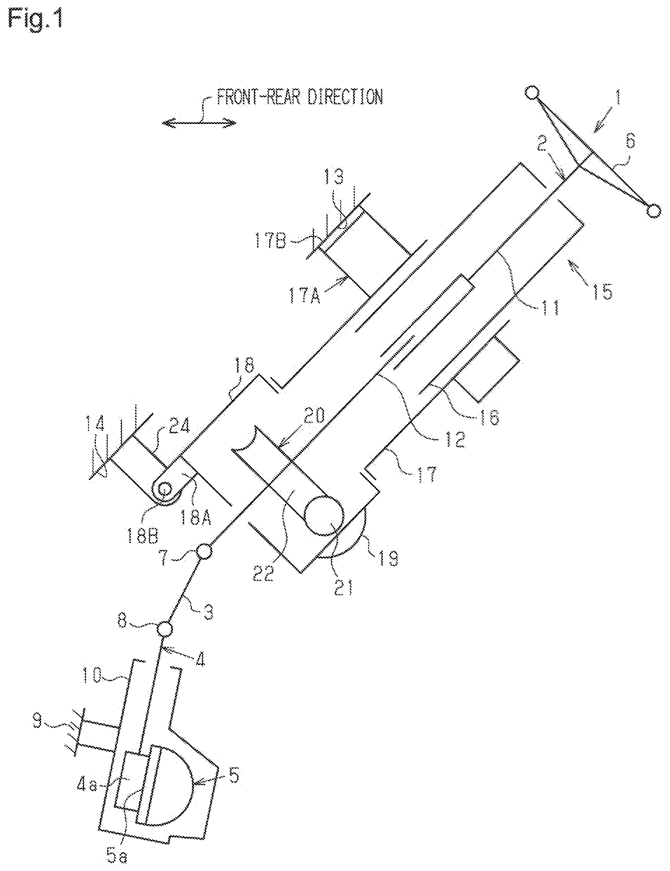

As shown in FIG. 1, a steering system 1 includes a steering shaft 2, an intermediate shaft 3, a pinion shaft 4, and a rack shaft 5. A steering wheel 6 is connected to a first end portion of the steering shaft 2. A first end portion of the intermediate shaft 3 is connected to a second end portion of the steering shaft 2 via a universal joint 7. A first end portion of the pinion shaft 4 is connected to a second end portion of the intermediate shaft 3 via a universal joint 8. A pinion 4a is provided on a second end portion of the pinion shaft 4. The pinion 4a meshes with a rack 5a on a rack shaft 5. The rack shaft 5 is supported inside a housing 10 fixed to a frame 9 of a vehicle body. The rack shaft 5 is movable in the right direction or the left direction with respect to the direction of travel of a vehicle. Both end portions of the rack shaft 5 are connected to right and left steered wheels (not shown) via tie rods (not shown).

The steering shaft 2 includes an outer shaft 11 and an inner shaft 12. The outer shaft 11 and the inner shaft 12 are connected to each other by, for example, spline connection. The outer shaft 11 and the inner shaft 12 can rotate together and can move relatively in the axial direction. The steering shaft 2 is disposed so as to be tilted with respect to the front-rear direction of the vehicle with the steering wheel 6 facing upward.

The steering system 1 includes a steering column 15. The steering shaft 2 is inserted through the steering column 15. The steering shaft 2 is supported via a bearing (not shown) so as to be rotatable with respect to the steering column 15. The steering column 15 is attached to two frames 13, 14 provided on the vehicle body. One frame 13 is located rearward of the other frame 14 in the front-rear direction of the vehicle. The surface of the frame 13 and the surface of the frame 14 are parallel to each other. The surfaces of the two frames 13, 14 are tilted with respect to the front-rear direction of the vehicle so that their tilt corresponds to the tilt of the steering shaft 2. The parallel surfaces of the frames 13, 14 include flat surfaces to which the steering column 15 is attached.

The steering column 15 includes an upper tube 16, a lower tube 17, and a housing 18. The upper tube 16 has a cylindrical shape. The lower tube 17 has a cylindrical shape and includes a flange 31. The upper tube 16 and the lower tube 17 are fitted together. As an example, the upper tube 16 is inserted into a first end portion of the lower tube 17. The first end portion is the opposite end portion from a second end portion with the flange 31. The upper tube 16 and the lower tube 17 can move relative to each other in the axial direction of the steering shaft 2. The lower tube 17 includes a column bracket 17A. The lower tube 17 is attached to the frame 13 of the vehicle body via the column bracket 17A. The column bracket 17A has mounting surfaces 17B to the surface of the frame 13. The entire mounting surfaces 17B contact the surface of the frame 13.

The upper tube 16 and the lower tube 17 constitute a support tube that rotatably supports the steering shaft 2.

The housing 18 is connected to the second end portion of the lower tube 17. The housing 18 includes two support portions 18A (only one is shown in FIG. 1) and a support shaft 18B. The two support portions 18A are provided on the opposite surface of the housing 18 from the lower tube 17. The two support portions 18A face each other in the width direction of the vehicle body. The support shaft 18B extends between the two support portions 18A. The support shaft 18B extends in the width direction of the vehicle body. The support shaft 18B is rotatably connected to a bracket 24 fixed to the frame 14 of the vehicle body. The support shaft 18B is parallel to the surface of the frame 14.

A motor 19 that assists in steering is provided outside the housing 18. A speed reducer 20 is housed inside the housing 18. The speed reducer 20 reduces the speed of rotation of the motor 19, and transfers the resultant rotation to the inner shaft 12. The speed reducer 20 is a worm speed reducer that includes a worm 21 and a worm wheel 22. The worm 21 is connected to an output shaft (not shown) of the motor 19 so that the worm 21 can rotate with the output shaft. The axis of the worm 21 and the axis of the output shaft of the motor 19 are on the same line. The worm wheel 22 meshes with the worm 21. The worm wheel 22 is mounted so that it can rotate with the inner shaft 12. The axis of the worm wheel 22 and the axis of the inner shaft 12 are on the same line.

The steering system 1 includes a lock mechanism (not shown). The lock mechanism selectively allows and prohibits swinging of the steering column 15 about the support shaft 18B and extension and retraction of the steering column 15 through an operation of locking or unlocking a lever (not shown). Performing an operation of unlocking the lever allows the steering column 15 to swing with respect to the column bracket 17A about the support shaft 18B. The vertical position of the steering wheel 6 can be adjusted by performing an operation of unlocking the lever and then moving the steering wheel 6 up or down. Performing an operation of unlocking the lever also allows the upper tube 16 to move in the axial direction of the steering shaft 2 with respect to the lower tube 17. The axial position of the steering wheel 6 can be adjusted by performing an operation of unlocking the lever and then moving the steering wheel 6 in the axial direction of the steering shaft 2.

Next, the configuration of the lower tube 17 will be described in detail.

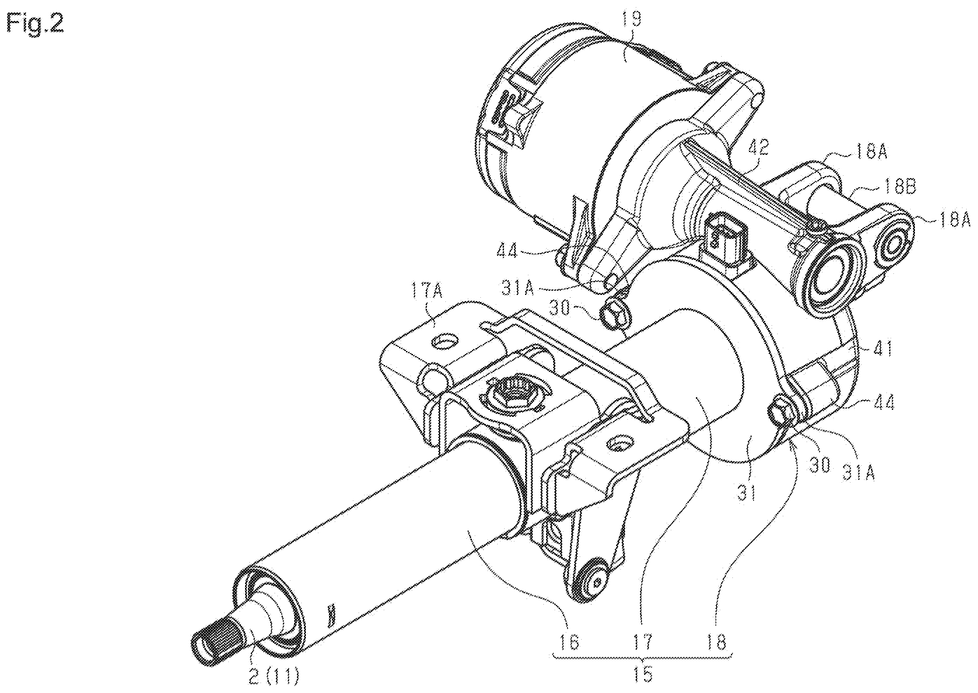

As shown in FIG. 2, the lower tube 17 includes the flange 31. The flange 31 is provided at the second end portion of the lower tube 17. The second end portion of the lower tube 17 is the opposite end portion from the first end portion into which the upper tube 16 is inserted. The flange 31 is in the form of an annular plate. The flange 31 includes two mounting portions 31A. The two mounting portions 31A are provided on the outer peripheral surface of the flange 31. The two mounting portions 31A protrude radially outward from the outer peripheral surface of the flange 31. The two mounting portions 31A are located on the opposite sides in the radial direction of the flange 31.

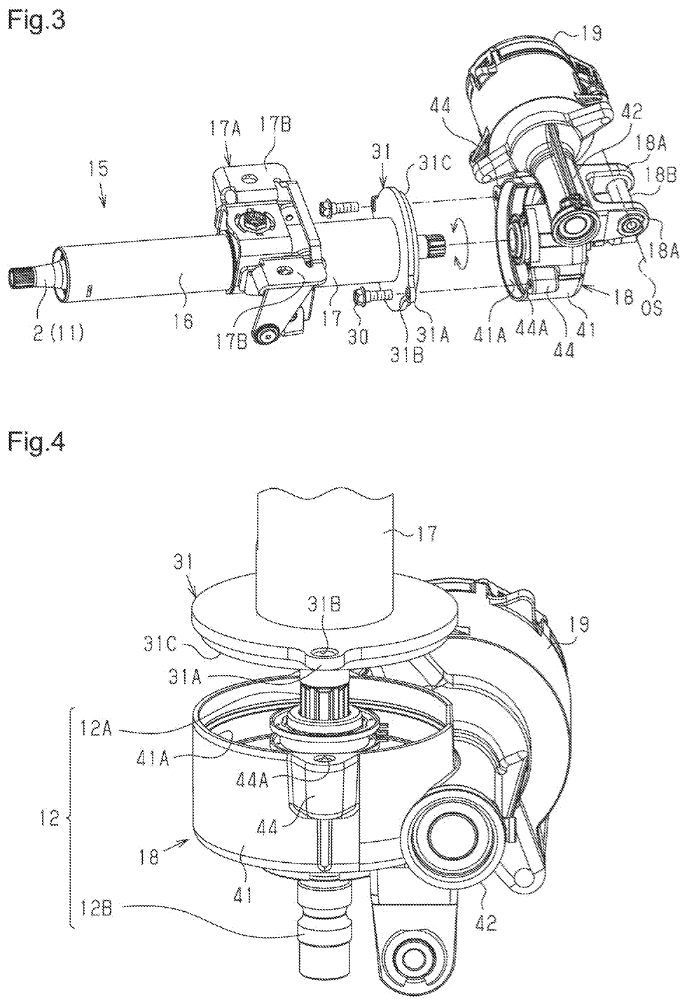

As shown in FIGS. 3 and 4, each of the two mounting portions 31A has an insertion hole 31B. The insertion holes 31B are circular holes. Bolts 30 are inserted through the insertion holes 31B. The flange 31 is fixed to the housing 18 by tightening the bolts 30 to the housing 18.

The flange 31 has an annular fitting portion 31C. The fitting portion 31C is a ridge extending in the circumferential direction of the flange 31. The outside diameter of the fitting portion 31C is smaller than the outside diameter of the flange 31. That is, the flange 31 is a stepped flange having a large diameter portion and a small diameter portion. The fitting portion 31C is provided on the opposite end face of the flange 31 from the lower tube 17. The outside diameter of the fitting portion 31C is smaller than the outside diameter of a worm wheel housing member 41.

As shown in FIG. 3, the column bracket 17A has two mounting surfaces 17B. The two mounting surfaces 17B are located next to each other in the width direction of the vehicle body. The direction in which the two mounting surfaces 17B are arranged is parallel to the axis OS of the support shaft 18B.

Next, the configuration of the housing 18 will be described in detail.

As shown in FIG. 2, the housing 18 includes the worm wheel housing member 41 and a worm housing member 42. Each of the worm wheel housing member 41 and the worm housing member 42 has a cylindrical shape. The worm housing member 42 is connected to the outer peripheral surface of the worm wheel housing member 41. The worm housing member 42 extends in a direction perpendicular to the axis of the worm wheel housing member 41. The inside of the worm wheel housing member 41 and the inside of the worm housing member 42 communicate with each other via a communication hole (not shown). The worm wheel housing member 41 forms a cylindrical portion of the housing 18. The housing 18 is made of metal such as aluminum.

The worm wheel 22 is rotatably housed inside the worm wheel housing member 41. The worm 21 is rotatably supported inside the worm housing member 42 via a bearing (not shown). The worm wheel 22 and the worm 21 mesh with each other via the communication hole inside the housing 18.

As shown in FIGS. 3 and 4, the worm wheel housing member 41 has an opening portion 41A in its first end portion in the axial direction, and has an end wall at its second end portion that is the opposite end portion from the first end portion. The opening portion 41A is open toward the lower tube 17 along the axis of the worm wheel housing member 41. The outside diameter of the worm wheel housing member 41 is substantially the same as the outside diameter of the flange 31. The inside diameter of the worm wheel housing member 41 is substantially the same as the outside diameter of the fitting portion 31C of the flange 31.

The worm wheel housing member 41 includes two tightening portions 44. The tightening portions 44 are portions to which the bolts 30 are tightened when fixing the flange 31 to the housing 18. The tightening portions 44 protrude radially outward from the outer peripheral surface of the worm wheel housing member 41. The two tightening portions 44 are located on the opposite sides in the radial direction of the worm wheel housing member 41. Each of the tightening portions 44 has a screw hole 44A. The screw holes 44A do not extend through the tightening portions 44. The end faces of the tightening portions 44 to which the screw holes 44A are open are flush with the end face of the worm wheel housing member 41 to which the opening portion 41A is open.

As shown in FIG. 4, the worm wheel housing member 41 rotatably supports the inner shaft 12. The inner shaft 12 extends through the worm wheel housing member 41. The axis of the inner shaft 12 and the axis of the worm wheel housing member 41 are on the same line. The inner shaft 12 includes an input shaft 12A, an output shaft 12B, and a torsion bar (not shown). The input shaft 12A and the output shaft 12B are connected to each other via the torsion bar. The output shaft 12B is a hollow cylinder.

### <Method for Assembling Steering Column>

Next, a method for assembling the steering column 15 will be described. The upper tube 16 and the lower tube 17 are assembled in advance.

When connecting the lower tube 17 and the housing 18, the flange 31 of the lower tube 17 and the opening portion 41A of the housing 18 are caused to face each other in the axial direction. In this state, the flange 31 and the housing 18 are brought closer to each other in the axial direction. At this time, the fitting portion 31C of the flange 31 is inserted into the opening portion 41A of the housing 18 while adjusting the rotational position of the flange 31 such that the insertion holes 31B of the flange 31 and the corresponding screw holes 44A of the housing 18 are aligned with each other. The peripheral edge of the flange 31 eventually abuts against the end face of the worm wheel housing member 41 to which the opening portion 41A is open. While maintaining this abutting state, the bolts 30 are inserted through the insertion holes 31B of the flange 31 from the opposite side from the housing 18, and the inserted bolts 30 are tightened to the tightening portions 44 of the housing 18. The flange 31 is thus fixed to the housing 18. That is, the lower tube 17 is connected to the housing 18 via the flange 31. The opening portion 41A of the housing 18 is kept closed by the flange 31. The flange 31 serves also as a cover that closes the opening portion 41A of the housing 18. The fitting portion 31C is kept fitted in the opening portion 41A of the housing 18.

There is the following concern when assembling the steering column 15.

The support tube including the upper tube 16 and the lower tube 17 is attached to the frame 13 of the vehicle body via the column bracket 17A. The housing 18 is rotatably attached to the frame 14 of the vehicle body via the support shaft 18B. At this time, it is necessary to connect the support tube and the housing 18 such that the mounting surfaces 17B of the column bracket 17A to the frame 13 and the axis OS of the support shaft 18B are parallel to each other. This is based on the fact that the surfaces of the two frames 13, 14 of the vehicle body are parallel to each other.

If the steering column 15 is attached to the vehicle body with the mounting surfaces 17B and the axis OS not parallel to each other, the column bracket 17A is fixed to the frame 13 with the column bracket 17A twisted about the axis of the steering column 15. Such twisting of the column bracket 17A may hinder smooth operation of the steering column 15 when adjusting the position of the steering wheel 6. The twisting of the column bracket 17A may also increase the load on the column bracket 17A.

Therefore, when connecting the support tube and the housing 18, it is necessary to tighten the bolts 30 while adjusting the relative rotational position between the support tube and the housing 18 such that the mounting surfaces 17B and the axis OS are parallel to each other as viewed in the axial direction of the steering column 15. However, this work of adjusting the rotational position is troublesome. Such work may also contribute reduction in ease of assembly of the steering column 15 to the vehicle body.

### <Connection Structure Between Support Tube and Housing 18>

In the present embodiment, the following configuration is used as a configuration for connecting the support tube and the housing 18.

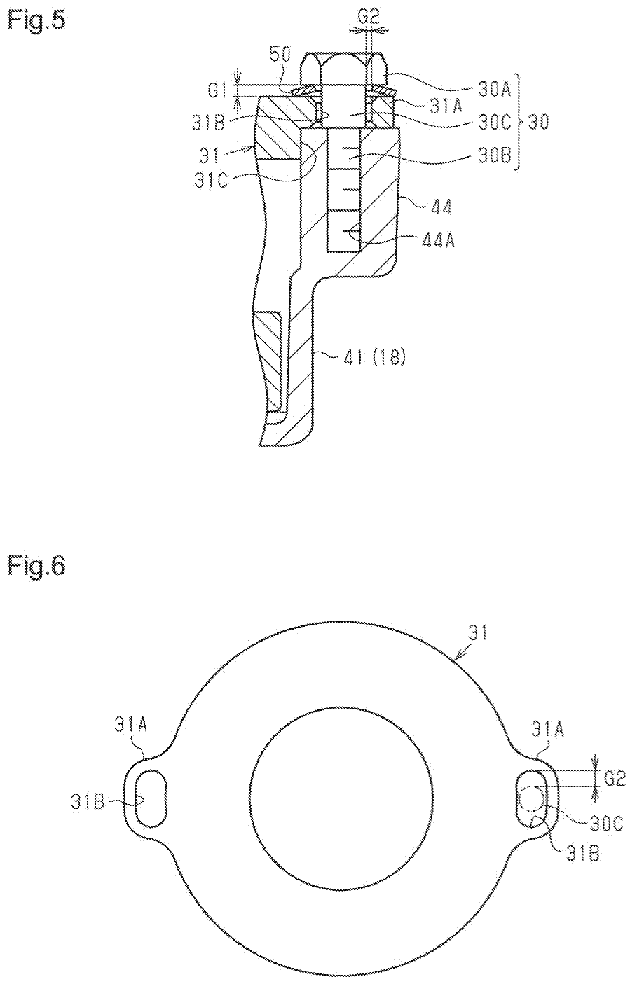

As shown in FIG. 5, the bolt 30 is a stepped bolt. The bolt 30 includes a head 30A, an external thread 30B, and an intermediate portion 30C. The intermediate portion 30C is located between the head 30A and the external thread 30B. The external thread 30B and the intermediate portion 30C constitute a shaft of the bolt 30. The external thread 30B has spiral grooves in its outer peripheral surface. The intermediate portion 30C has no groove in its outer peripheral surface. The outer peripheral surface of the intermediate portion 30C is a curved surface without irregularities. The outside diameter of the intermediate portion 30C is larger than the nominal diameter of the external thread 30B. The nominal diameter refers to the maximum diameter of the external thread 30B, that is, the outside diameter of the ridge portions of the external thread 30B. The axial length of the intermediate portion 30C is larger than the axial length of the mounting portion 31A of the flange 31, that is, the thickness of the mounting portion 31A. The inside diameter of the insertion hole 31B in the mounting portion 31A is larger than the outside diameter of the intermediate portion 30C.

The intermediate portion 30C has, on the opposite side from the head 30A, an end face facing the end face of the tightening portion 44 to which the screw hole 44A is open. With the external thread 30B of the bolt 30 tightened in the screw hole 44A of the tightening portion 44, the end face of the intermediate portion 30C axially abuts against the end face of the tightening portion 44 to which the screw hole 44A is open. That is, the bolt 30 is tightened to a position where the intermediate portion 30C axially abuts against the tightening portion 44 around the screw hole 44A. There is clearance G1 between the head 30A and the mounting portion 31A of the flange 31. The axial length of the clearance G1 is the difference between the axial length of the intermediate portion 30C and the thickness of the mounting portion 31A. There is clearance G2 between the outer peripheral surface of the intermediate portion 30C and the inner peripheral surface of the insertion hole 31B.

A disc spring 50 is interposed between the head 30A and the mounting portion 31A. The disc spring 50 is an example of the elastic body. The disc spring 50 is kept compressed in the axial direction. The housing 18 and the flange 31 are held by the axial force of the disc spring 50 in such a manner that their relative rotation about the axis is reduced. The axial force of the disc spring 50 is a force in the axial direction of the disc spring 50 and refers to a spring reaction force or elastic force generated by compression of the disc spring 50. The axial force of the disc spring 50 is adjusted to be large enough that the flange 31 and the housing 18 do not rotate relative to each other even if, for example, an operator holds the steering column 15 by hand. The axial force of the disc spring 50 is determined by the axial length of the intermediate portion 30C and the thickness of the mounting portion 31A. That is, the amount of compression of the disc spring 50 is adjusted by adjusting the axial length of the clearance G1 between the head 30A and the mounting portion 31A. The disc spring 50 generates an axial force corresponding to the amount of compression thereof.

When a force larger than the holding force of the disc spring 50 is applied to the flange 31 in such a direction that causes the flange 31 and the housing 18 to rotate relative to each other, the flange 31 and the housing 18 rotate relative to each other within the range of the clearance G2. The holding force of the disc spring 50 refers to the force of the disc spring 50 that reduces relative rotation between the flange 31 and the housing 18. The force larger than the holding force of the disc spring 50 is a force in such a direction that causes the flange 31 and the housing 18 to rotate relative to each other. Relative rotation between the flange 31 and the housing 18 is restricted by the outer peripheral surface of the intermediate portion 30C and the inner peripheral surface of the insertion hole 31B engaging with each other.

### Functions of First Embodiment

Next, functions of the first embodiment will be described.

For example, when attaching the steering column 15 to the vehicle body, the support shaft 18B is first attached to the frame 14 of the vehicle body via the bracket 24. The support tube including the upper tube 16 and the lower tube 17 is then attached to the frame 13 of the vehicle body via the column bracket 17A. The column bracket 17A is fixed to the frame 13 by, for example, bolts (not shown). The surfaces of the two frames 13, 14 are parallel to each other.

There are cases where the mounting surface 17B of the column bracket 17A and the axis OS of the support shaft 18B are not parallel to each other in the assembled steering column 15. For example, the mounting surface 17B may be tilted clockwise or counterclockwise with respect to the axis OS as viewed in the axial direction of the steering column 15. In this case, even if the support shaft 18B is able to be attached to the frame 14 such that the axis OS becomes parallel to the surface of the frame 14, the mounting surface 17B does not become parallel to the surface of the frame 13.

Therefore, as the column bracket 17A is attached to the frame 13 of the vehicle body, a force is applied to the lower tube 17 via the column bracket 17A in such a direction that causes the flange 31 to rotate with respect to the housing 18. When this applied force is larger than the holding force of the disc spring 50, the flange 31 rotates relative to the housing 18 against the holding force of the disc spring 50. The flange 31 can rotate within the range of the clearance G2.

As the flange 31 rotates, the attitude of the column bracket 17A changes so that the mounting surface 17B follows the surface of the frame 13. Therefore, the mounting surface 17B becomes parallel to the surface of the frame 13 when the amount of tilt of the mounting surface 17B with respect to the axis OS in the clockwise or counterclockwise direction is within the range of the clearance G2 as viewed in the axial direction of the steering column 15. By fixing the column bracket 17A to the frame 13 in this state, the mounting surface 17B and the axis OS are kept parallel to each other.

### Effects of First Embodiment

Therefore, the first embodiment has the following effects.

(1-1) Assuming that the surfaces of the two frames 13, 14 of the vehicle body are parallel to each other, the following effects can be obtained. In the case where the mounting surface 17B and the axis OS of the support shaft 18B are not parallel to each other, the attitude of the column bracket 17A changes so that the mounting surface 17B follows the surface of the frame 13 as the steering column 15 is attached to the vehicle body. Therefore, the mounting surface 17B and the axis OS become parallel each other when the amount of tilt of the mounting surface 17B with respect to the axis OS in the clockwise or counterclockwise direction is within the range of the clearance G2 as viewed in the axial direction of the steering column 15. That is, there is no need to exactly adjust the relative rotational position between the flange 31 and the housing 18 when assembly the steering column 15. The ease of assembly of the steering column 15 is therefore improved. As a result, the ease of assembly of the steering system 1 is also improved.

(1-2) There are cases where the surfaces of the two frames 13, 14 of the vehicle body are not parallel to each other. For example, the surface of the frame 13 may be tilted clockwise or counterclockwise with respect to the surface of the frame 14 as viewed in the axial direction of the steering column 15. Even in this case, as the steering column 15 is attached to the vehicle body, the attitude of the column bracket 17A changes so that the mounting surface 17B follows the surface of the frame 13. Therefore, the column bracket 17A can be attached to the frame 13 when the amount of tilt of the mounting surface 17B relative to the axis OS in the clockwise or counterclockwise direction is within the range of the clearance G2 as viewed in the axial direction of the steering column 15. Accordingly, there is no need to exactly adjust the relative rotational position between the flange 31 and the housing 18 when assembly the steering column 15. The case of assembly of the steering column 15 is therefore improved. The column bracket 17A will not be twisted around the axis of the steering column 15. As a result, the load on the column bracket 17A is reduced.

(1-3) Since the bolt 30 is tightened to a position where the intermediate portion 30C abuts against the tightening portion 44 in the axial direction, the disc spring 50 can be appropriately compressed. The disc spring 50 therefore generates an appropriate axial force required to reduce relative rotation between the housing 18 and the flange 31. Since it is not necessary to exactly control the tightening torque of the bolt 30, it facilitates the work of tightening the bolt 30.

(1-4) When assembling the lower tube 17 and the housing 18, axial movement of the flange 31 is guided by the fitting portions 31C. That is, radial movement of the flange 31 with respect to the housing 18 is restricted by the outer peripheral surface of the fitting portion 31C engaging with the inner peripheral surface of the opening portion 41A in the radial direction. Since the fitting portion 31C is thus fitted in the opening portion 41A, the lower tube 17 and the worm wheel housing member 41 are kept coaxial with each other. Since so-called centering work is not necessary, the efficiency in the work of assembling the lower tube 17 and the housing 18 is improved. The steering column 15 can therefore be more easily assembled. The centering work refers to the work of adjusting the relative positional relationship between the lower tube 17 and the worm wheel housing member 41 so that the lower tube 17 and the worm wheel housing member 41 are disposed coaxially.

(1-5) Since the lower tube 17 and the worm wheel housing member 41 are kept coaxial with each other, the following effects can also be obtained. Of the members provided inside the lower tube 17 and the members provided inside the housing 18, coaxiality between the members that should be disposed coaxially with each other is also ensured. For example, coaxiality between the inner shaft 12 and the worm wheel 22 is ensured.

### Second Embodiment

Next, a second embodiment of the steering system will be described. The present embodiment basically has the same configuration as the first embodiment shown in FIGS. 1 to 6. The present embodiment is different from the first embodiment in the configuration of the flange 31. Therefore, the same components as those in the first embodiment will be denoted by the same signs as those in the first embodiment, and detailed description thereof will be omitted.

As shown in FIG. 6, the flange 31 has two insertion holes 31B. These insertion holes 31B are elongated holes extending in the circumferential direction of the flange 31 as viewed in the axial direction of the flange 31. The dimension of the insertion hole 31B in the radial direction of the flange 31 is substantially the same as, for example, the outside diameter of the intermediate portion 30C of the bolt 30. Therefore, the outer peripheral surface of the intermediate portion 30C contacts the inner peripheral surface of the insertion hole 31B in the radial direction of the flange 31, as viewed in the axial direction of the flange 31.

Clearance G2 is provided between the outer peripheral surface of the intermediate portion 30C and the inner peripheral surface of the insertion hole 31B in the circumferential direction of the flange 31. The intermediate portion 30C is movable between a first inner end and a second inner end of the insertion hole 31B in the circumferential direction of the flange 31. That is, the flange 31 and the housing 18 can oppose each other in the circumferential direction of the flange 31 within the range of the clearance G2.

When a force larger than the holding force of the disc spring 50 is applied to the flange 31 and the housing 18 as the steering column 15 is attached to the vehicle body, the flange 31 and the housing 18 rotate relative to each other in the circumference direction of the flange 31 within the range of the clearance G2. As the flange 31 rotates, the attitude of the column bracket 17A changes so that the mounting surface 17B follows the surface of the frame 13. Therefore, the mounting surface 17B becomes parallel to the surface of the frame 13 when the amount of tilt of the mounting surface 17B with respect to the axis OS in the clockwise or counterclockwise direction is within the range of the clearance G2 as viewed in the axial direction of the steering column 15.

### Effects of Second Embodiment

The second embodiment therefore has the following effects in addition to the effects (1-1) to (1-5) of the first embodiment.

(2-1) The insertion holes 31B are elongated holes extending in the circumferential direction of the flange 31. Therefore, the range of relative movement between the insertion hole 31B and the flange 31 of the intermediate portion 30C in the circumferential direction can be increased compared to the case where the insertion hole 31B is a circular hole. Accordingly, the range of adjustment of the relative rotational position between the flange 31 and the housing 18 is increased. The column bracket 17A can be attached in an appropriate attitude to the frame 13 even when the mounting surface 17B is relatively greatly tilted with respect to the axis OS in the clockwise or counterclockwise direction as viewed in the axial direction of the steering column 15. As the steering column 15 is attached to the vehicle body, the attitude of the column bracket 17A is adjusted so that the mounting surface 17B and the axis OS become parallel to each other.

(2-2) The outer peripheral surface of the intermediate portion 30C contacts the inner peripheral surface of the insertion hole 31B in the radial direction of the flange 31, as viewed in the axial direction of the flange 31. Therefore, radial movement of the flange 31 with respect to the housing 18 is restricted by the outer peripheral surface of the intermediate portion 30C engaging with the inner peripheral surface of the insertion hole 31B in the radial direction of the flange 31. Therefore, a configuration in which the fitting portion 31C is omitted from the flange 31 may be used depending on the product specifications.

(2-3) The dimension of the insertion hole 31B in the radial direction of the flange 31 may be larger than the outside diameter of the intermediate portion 30C of the bolt 30. Even in this case, radial movement of the flange 31 with respect to the housing 18 is restricted by the outer peripheral surface of the fitting portion 31C engaging with the inner peripheral surface of the opening portion 41A in the radial direction.

### Third Embodiment

Next, a third embodiment of the steering system will be described. The present embodiment basically has the same configuration as the first embodiment shown in FIGS. 1 to 6. Therefore, the same components as those in the first embodiment will be denoted by the same signs as those in the first embodiment, and detailed description thereof will be omitted.

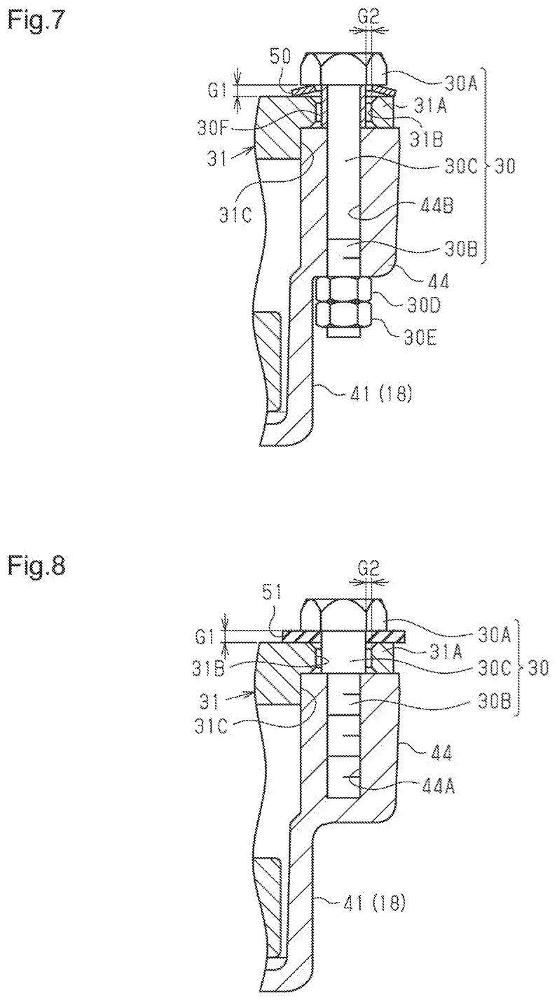

As shown in FIG. 7, the bolt 30 is a through bolt. The bolt 30 includes the head 30A, the external thread 30B, and the intermediate portion 30C. The outside diameter of the intermediate portion 30C is substantially the same as or slightly smaller than the nominal diameter of the external thread 30B. The sum of the axial length of the external thread 30B and the axial length of the intermediate portion 30C is greater than the sum of the axial length of the mounting portion 31A of the flange 31 and the axial length of the tightening portion 44.

The tightening portion 44 has a through hole 44B. The through hole 44B extends through the tightening portion 44 in the axial direction. The inside diameter of the through hole 44B is substantially the same as or slightly larger than the nominal diameter of the external thread 30B. The through hole 44B corresponds to the insertion hole 31B of the flange 31.

The bolt 30 is inserted through the insertion hole 31B and the through hole 44B from the opposite side from the housing 18. Part of the intermediate portion 30C is inserted into the through hole 44B. The external thread 30B has a distal end portion on the opposite side from the head 30A, and this distal end portion protrudes from the opposite surface of the tightening portion 44 from the flange 31. Two nuts 30D, 30E are tightened on the distal end portion of the external thread 30B. The flange 31 and the housing 18 are thus connected to each other.

A cylindrical spacer 30F is mounted on the outer peripheral surface of the intermediate portion 30C. The inside diameter of the spacer 30F is substantially the same as the outside diameter of the intermediate portion 30C. The outside diameter of the spacer 30F is smaller than the inside diameter of the insertion hole 31B. The outside diameter of the spacer 30F is larger than the inside diameter of the through hole 44B. The axial length of the spacer 30F is larger than the axial length of the mounting portion 31A. The spacer 30F is interposed between the head 30A and the tightening portion 44.

The spacer 30F has a first end face facing the head 30A and a second end face facing the tightening portion 44 around the through hole 44B. With the nuts 30D, 30E tightened on the external thread 30B of the bolt 30, the first end face of the spacer 30F abuts against the head 30A in the axial direction. Moreover, with the nuts 30D, 30E tightened on the external thread 30B of the bolt 30, the second end face of the spacer 30F axially abuts against the end face of the tightening portion 44 to which the through hole 44B is open.

With the nuts 30D, 30E tightened on the external thread 30B of the bolt 30, there is clearance G1 between the head 30A and the mounting portion 31A. The axial length of the clearance G1 is the difference between the axial length of the spacer 30F and the thickness of the mounting portion 31A. With the nuts 30D, 30E tightened on the external thread 30B of the bolt 30, there is clearance G2 between the outer peripheral surface of the spacer 30F and the inner peripheral surface of the insertion hole 31B.

Since the spacer 30F is kept interposed between the head 30A and the tightening portion 44, the disc spring 50 is kept appropriately compressed. Therefore, in the case where the mounting surface 17B of the column bracket 17A and the axis OS of the support shaft 18B are not parallel to each other, the following function is obtained as the steering column 15 is attached to the vehicle body. When a force larger than the holding force of the disc spring 50 is applied to the lower tube 17 as the steering column 15 is attached to the vehicle body, the flange 31 rotates with respect to the housing 18 against the holding force of the disc spring 50. Therefore, when the amount of tilt of the mounting surface 17B with respect to the axis OS in the clockwise or counterclockwise direction is within the range of the clearance G2 as viewed in the axial direction of the steering column 15, the attitude of the column bracket 17A is adjusted so that the mounting surface 17B and the axis OS become parallel to each other.

The third embodiment therefore has the same effects as the effects (1-1) to (1-5) of the first embodiment.

The spacer 30F may be omitted. In this case, the clearance G1 defined between the head 30A and the mounting portion 31A of the flange 31 is secured by managing the tightening torque for the bolt 30. The disc spring 50 is thus appropriately compressed in the axial direction of the bolt 30. The bolt 30 having only the head 30A and the external thread 30B may be used. In this case, the external thread 30B corresponds to the shaft of the bolt 30.

### Fourth Embodiment

Next, a fourth embodiment of the steering system will be described. The present embodiment basically has the same configuration as the first embodiment shown in FIGS. 1 to 6. Therefore, the same components as those in the first embodiment will be denoted by the same signs as those in the first embodiment, and detailed description thereof will be omitted.

As shown in FIG. 8, a rubber member 51 is interposed between the head 30A of the bolt 30 and the tightening portion 44 instead of the disc spring 50. The rubber member 51 is in the form of, for example, an annular circular plate having a through hole. The rubber member 51 is an example of the elastic body. The rubber member 51 has a larger axial length than the clearance G1. The rubber member 51 is kept compressed in the axial direction. The housing 18 and the flange 31 are held by the elastic force of the rubber member 51 in such a manner that their relative rotation is reduced.

When a force larger than the holding force of the rubber member 51 is applied to the flange 31 in such a direction that causes the flange 31 and the housing 18 to rotate relative to each other, the flange 31 and the housing 18 rotate relative to each other within the range of the clearance G2. The holding force of the rubber member 51 refers to the force of the rubber member 51 that reduces relative rotation between the flange 31 and the housing 18.

The fourth embodiment therefore has the same effects as the effects (1-1) to (1-5) of the first embodiment.

1. A steering system, comprising:
a cylindrical support tube that includes a flange and that rotatably supports a steering shaft;
a speed reducer configured to apply torque to the steering shaft;
a housing that includes a cylindrical portion housing the speed reducer, the cylindrical portion being disposed coaxially with the flange;
a column bracket mounted on the support tube and having a mounting surface for a vehicle body;
a support shaft that extends in a width direction of the vehicle body and that supports the housing in such a manner that the housing is rotatable with respect to the vehicle body; and
a bolt that connects the flange and the cylindrical portion to each other, wherein
the bolt includes a head and a shaft,
the flange has an insertion hole through which the shaft is inserted,
there is clearance between an outer peripheral surface of the shaft and an inner peripheral surface of the insertion hole at least in a circumferential direction of the flange, and the clearance allows relative rotation between the flange and the cylindrical portion,
an elastic body is interposed, in a compressed state in an axial direction of the bolt, between the head and the flange, so that the elastic body applies an elastic force that reduces the relative rotation between the flange and the cylindrical portion,
the shaft includes an external thread and an intermediate portion located between the head and the external thread,
the cylindrical portion has a screw hole into which the external thread is tightened,
an outside diameter of the intermediate portion is larger than an inside diameter of the screw hole, so that the intermediate portion includes, on an opposite side from the head, an end face facing the cylindrical portion around the screw hole,
an axial length of the intermediate portion is larger than an axial length of the insertion hole, and
the external thread is tightened in the screw hole, so that the end face of the intermediate portion is kept abutting against the cylindrical portion in the axial direction and the elastic body is kept compressed in the axial direction between the head and the flange.

2. The steering system according to claim 1, wherein the flange includes a fitting portion that is fitted to an inner peripheral surface of the cylindrical portion to restrict radial movement of the flange with respect to the cylindrical portion.

3. The steering system according to claim 1, wherein the insertion hole is a circular hole or an elongated hole extending in the circumferential direction of the flange, as viewed in an axial direction of the flange.

4. The steering system according to claim 1, wherein the elastic body is a disc spring or a rubber member through which the shaft is inserted.

5. The steering system according to claim 1, wherein
the speed reducer includes a worm wheel that rotates with the steering shaft and a worm that meshes with the worm wheel,
the housing includes a worm wheel housing member housing the worm wheel and a worm housing member housing the worm, and
the cylindrical portion is the worm wheel housing member.

6. (canceled)

7. (canceled)
